(19) United States
(12) Patent Application Publication
(10) Pub. No.: US 2006/0202390 A1
(43) Pub. Date: Sep. 14, 2006

(54) Process and apparatus for producing components

(76) Inventors: Joachim Flaig, Kongen (DE); Michael Konig, Wustenriet (DE)

Correspondence Address: CLARK HILL, P.C., 500 WOODWARD AVENUE, SUITE 3500, DETROIT, MI, 48226, US

(21) Appl. No.: 11/371,748

(22) Filed: Mar. 9, 2006

(30) Foreign Application Priority Data
Mar. 9, 2005 (DE) 10 2005 012 106.3

(51) Int. Cl. B29C 45/56

(52) U.S. Cl. 264/325; 425/449

(57) ABSTRACT

A process and an apparatus are described for producing a component in a tool. A plastics material is introduced into a cavity (12) of the tool and a tool apparatus (10) exerts a first force on the plastics material, thereby stamping it. In addition, a second force is introduced which exerts a second force on the plastics material.

### BACKGROUND OF THE INVENTION

1. Technical Field

The present invention relates to a process, a tool, and a tool apparatus for producing a component, particularly, a process and an apparatus for producing a component using an injection compression technique.

2. Description of the Related Art

Injection compress processes in which components are manufactured by injecting a plastics material or a molding composition into a cavity or mold cavity and then stamping the molding composition are known particularly in the production of flat components. In these processes, the plastics material is first introduced in a heated moldable state, by means of suitable nozzles, into the cavity which is a shaped to correspond to the shape of the component to be produced. Then, using a tool apparatus, in a so-called closing movement, a force is exerted on the plastics material which is thereby stamped and in this way the component is molded in the desired manner.

After the molding, the components are taken out of the mold cavity and then regularly painted to achieve the desired surface effects.

The apparatus or tools known for these processes are designed to hold the mold cavity which receives the molding composition in a heated state and to exert thereon a force directed in one direction for stamping the component which is to be produced. During the stamping, the apparatus is usually cooled or, if necessary, tempered.

It has been found that unsatisfactory results are obtained with known injection molding processes, particularly, in the case of complex components.

### SUMMARY OF THE INVENTION

The process of producing a component, particularly a plastics component, according to the invention, provides that a plastics material is introduced into a cavity and by a first application of force using a tool apparatus in a closing movement of the tool apparatus, a first force is exerted on the plastics material and this material is thus stamped. In addition, at least one second application of force takes place, exerting a second force on the plastics material. These different applications of force are generally carried out at the same time and thus together stamp the plastics material.

Suitable plastics materials or molding or backfilling compositions may be, in particular, thermoplastic and thermosetting materials, such as polypropylene, for example.

The minimum of one second force is preferably directed substantially perpendicularly to the first force and usually acts on the plastics material at a different point. It should be borne in mind that consequently during the closing process of the tool apparatus which carries out the stamping of the plastics material, forces from different directions may be applied to different points of the plastics material contained in the cavity and in this way complex, thin-walled components can be produced, which are low in tension, free from distortion, and highly accurate. The manufacture of strongly curved components is also made easier.

In a preferred embodiment, before the plastics material is put in, a film is placed in the cavity which bonds to the plastics material subsequently introduced and forms the surface of the manufactured component. This does away with the need for subsequent painting and thus eliminates an additional step of the process. This film may consist of a laminate of several layers.

Preferably, the plastics material is injected into the cavity using at least one injection nozzle. The nozzles are preferably arranged so as to allow the plastics material to be injected directly into the cavity and, when the film has already been placed therein, to enable the plastics material to be injected directly onto a reverse side of the film. This way, cold channels can be avoided.

In a preferred embodiment, the tool apparatus is cooled or, if necessary, tempered during the stamping process.

The tool according to the invention serves to manufacture a component and, in particular, carry out a process as described above and is designed to exert a first force, imparted by a closing movement of a tool apparatus, onto a plastics material introduced into a cavity and additionally to exert a second force on the plastics material.

Preferably, the tool according to the invention which is provided for exerting the second force is a moving device such as a hydraulic cylinder.

The tool apparatus according to the invention serves to produce a component and, in particular, to carry out the process described hereinbefore. It comprises a delivery device for placing a plastics material in a cavity and a first moving device for carrying out a closing movement of the tool apparatus, by means of which a first force is to be exerted and hence compression of the plastic contained in the cavity is to be carried out. The tool apparatus is constructed so that additionally a second force can be exerted on the plastics material.

As a result, it is possible to apply forces from different directions to different points of the plastics material for the stamping process.

A second moving device, e.g., a hydraulic cylinder, may be provided for exerting the second force.

The delivery device comprises an injection device having at least one injection nozzle.

This minimum of one injection nozzle is preferably arranged so as to enable direct injection into the cavity, so as to prevent cold channels. If a film has already been placed in the cavity before the injection process, the material can be injected directly onto one side of the film, namely, the reverse side of the film, using the nozzles thus arranged. The front surface of the film then forms the surface of the finished component.

According to a preferred embodiment of the tool apparatus, at least one hydraulic cylinder is also provided by means of which an opening of the cavity can be closed during the stamping process.

Preferably, a cooling device is provided by means of which the entire arrangement can be cooled or tempered.

### BRIEF DESCRIPTION OF THE DRAWINGS

Other advantages of the invention will be readily appreciated as the same being better understood by reference to the following detailed description when considered in connection with the accompanying drawing, wherein:

FIG. 1 is a schematic view of a preferred embodiment of the apparatus according to one aspect of the invention.

### DETAILED DESCRIPTION OF THE PREFERRED EMBODIMENT

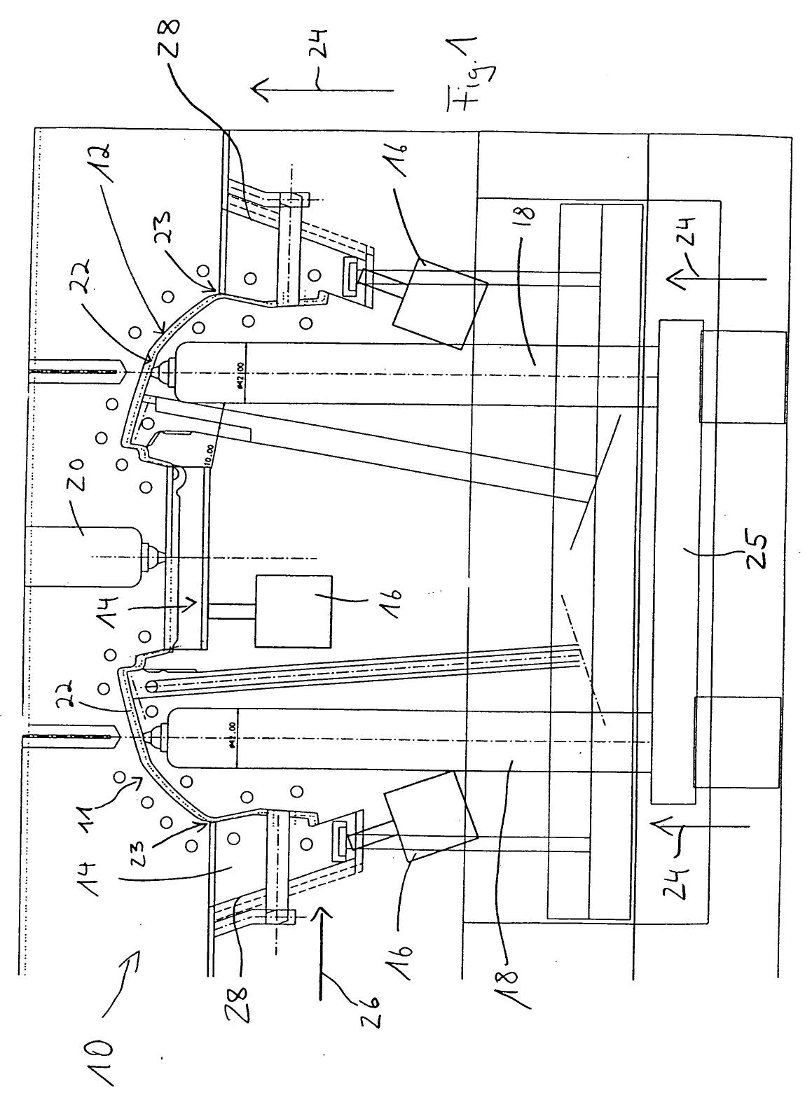

FIG. 1 shows, in schematic view, a preferred embodiment of the tool apparatus according to the invention, generally designated 10, which acts on a tool 11.

This tool apparatus 10 surrounds a cavity 12, or mold cavity, which plastics material which is to be molded is placed.

The tool apparatus 10 comprises a frame 14. Also shown are a number of hydraulic cylinders 16, two injection nozzles 18 directed into the cavity 12 and an alternative auxiliary injection nozzle 20. In practical application, it is normal to have either the injection nozzles 18 or the alternative auxiliary injection nozzle 20.

A film 22 is placed in the cavity 12, as shown by broken lines, and during the stamping process, this film bonds to the plastics material and eventually forms the surface of the finished component.

Thus, during manufacture, the film 22 is first placed in the cavity 12. Then the tool 11 is closed, apart from a desired stamping gap 23. Then, the plastics material is introduced into the cavity 12 through the injection nozzles 18. The injection nozzles 18 are arranged so as to inject directly into the cavity 12, and specifically directly onto the reverse side of the film 22. In this way, cold channels are avoided.

The compression process is then carried out. In this case, it is affected by a movement, exerted in the direction of the arrow 24, of one-half of the tool apparatus 10 with a first moving device 25. It can be seen that this movement introduces a force onto the plastics material in the direction of the arrow 24, i.e., the material is compressed and thus stamped and molded.

In addition to this closing movement, another movement brought about by the hydraulic cylinder 16 and a gradient 28 takes place in the direction of an arrow 26 with at least part of the frame 14 on the left hand side of the tool apparatus 10. In this way, another force is applied, i.e., a second force is exerted onto the plastics material in the cavity 12, which is preferably perpendicularly to the force produced by the closing movement. A similar process takes place on the right hand side of the tool apparatus 10.

With the hydraulic cylinders 16, an opening of the cavity 12 can be closed during the stamping process. The alternative injection nozzle 20 may alternatively introduce plastics material into the cavity 12.

By a suitable arrangement of a number of moving devices, particularly by a suitable choice of points where force is applied and the directions of the forces introduced, it is thus possible to manufacture complex, thin-walled, even highly curved components. This applies to both single and multi-cavity tools.

What is claimed is:

1. A process for producing a component, wherein:
a plastics material is introduced into a cavity (12),
a first force is exerted on the plastics material through a first application of force by means of a tool apparatus (10) in a closing movement of the tool apparatus (10), thus stamping the plastics material, and
at least one second application of force takes place which exerts a second force on the plastics material.

2. The process according to claim 1, wherein the second force is directed substantially perpendicularly to the first force.

3. The process according to claim 2, wherein a film (22) is placed in the cavity (12) before the plastics material is introduced.

4. The process according to claim 3, wherein the plastics material is injected into the cavity (12).

5. The process according to claim 4, wherein the plastics material is injected directly onto a reverse side of the film (22).

6. The process according to claim 5, wherein the tool apparatus (10) is cooled.

7. The process according to claim 5, wherein the tool apparatus (10) is tempered.

8. A tool apparatus (10) for producing a component within a tool (11), said tool apparatus comprising:
a delivery device for introducing a plastics material into a cavity (12) of the tool (11);
a first moving device (25) for closing the tool apparatus (10) and exerting a first force on the plastics material, stamping the plastics material in the cavity (12); and
a second moving device for exerting a second force on the plastics material.

9. The tool apparatus according to claim 8, wherein a hydraulic cylinder (16) is used as the second moving device.

10. The tool apparatus according to claim 8, wherein the delivery device is an injection device having at least one injection nozzle (18).

11. The tool apparatus according to claim 10, wherein at least one injection nozzle (18) is arranged so as to enable direct injection into the cavity (12).

12. The tool apparatus according to claim 11, further including a cooling device.

13. The tool apparatus according to claim 11, further including a tempering device.
